(19) United States
(12) Patent Application Publication
(10) Pub. No.: US 2026/0111609 A1
(43) Pub. Date: Apr. 23, 2026

(54) Contextual Entitlement Provisioning for Video Recordings

(71) Applicant: The PNC Financial Services Group, Inc., Pittsburgh, PA (US)

(72) Inventor: Anthony MARMO, Pittsburgh, PA (US)

(21) Appl. No.: 19/362,722

(22) Filed: Oct. 20, 2025

Related U.S. Application Data
(60) Provisional application No. 63/709,576, filed on Oct. 21, 2024.

(51) Int. Cl. G06F 21/62; G06F 21/60; H04L 65/403; H04N 5/76

(52) U.S. Cl. CPC G06F 21/629; G06F 21/604; H04L 65/403; H04N 5/76

(57) ABSTRACT

Systems and methods for video conference meeting provisioning by distributing meeting entitlement on a per meeting basis are provided. A user request for a video conference meeting is received by a provisioning application, which identifies meeting context information from the user request and one or more data sources, determines a meeting recording entitlement for the video conference meeting based upon the meeting context information; and transmits the meeting recording entitlement to video conferencing software. Then the video conferencing system permits or prohibits a particular user to record the requested video conference meeting.

### CROSS-REFERENCE TO RELATED APPLICATIONS

This application claims priority to U.S. Provisional Application No. 63/709,576, filed Oct. 21, 2024, which is incorporated herein by reference in its entirety.

### FIELD

The present disclosure relates to video conference provisioning, and in particular to video conference meeting recording entitlements.

### BACKGROUND

Video conferencing has become pervasive. It conveniently enables multimodal communication between people in both the commercial and personal world on an on demand basis. In such video meetings, a substantial amount of information that would have been communicated in a live meeting can be communicated between the participants. Where in-person meetings often come with significant time and monetary costs, a video meeting can be arranged and held near instantly, regardless of the location of the participants.

### SUMMARY

Systems and methods for video conference meeting provisioning by distributing meeting entitlement on a per meeting basis are provided. A user request for a video conference meeting is received by a provisioning application, which identifies meeting context information from the user request and one or more data sources, determines a meeting recording entitlement for the video conference meeting based upon the meeting context information; and transmits the meeting recording entitlement to video conferencing software. Then the video conferencing system permits or prohibits a particular user to record the requested video conference meeting.

### BRIEF DESCRIPTION OF DRAWINGS

FIG. 1 is a diagram depicting an embodiment of a provisioning application for distributing meeting recording entitlements, where a user request for a meeting recording is submitted to a video conference software.

FIG. 2 is a diagram depicting an embodiment of a provisioning application for distributing meeting recording entitlements, where a user request for a meeting recording is submitted to the provisioning application.

FIG. 3 is a diagram depicting an auditing application for video conference meeting recordings entitlements.

FIG. 4A is a flow diagram depicting a provisioning application evaluating a request for a video conference with recording enabled.

FIG. 4B is a flow diagram depicting an auditing application verifying a meeting recording matches meeting context information.

FIG. 5 is a flow diagram depicting a method for video conference provisioning.

FIG. 6 is a diagram depicting an example video conference data structure.

FIGS. 7A, 7B, and 7C depict example systems for implementing the approaches described here for contextual video conference meeting provisioning.

### DETAILED DESCRIPTION

Despite the benefits of on-demand and scheduled video conferencing technologies, it may sometimes be the case that a participant is unable to attend (e.g., they are on vacation, they are participating in another meeting). In such instances, it may be desirable to record the video conference for the missing participant to view later. In other instances, such as company training sessions, it may be desirable for video conferences to be recorded for later viewing by multiple/many viewers, such as employees who are hired after the live training session occurred.

But it may be undesirable for users to be able to record all video conferences. Video conferences may sometimes reveal sensitive information, such as company trade secrets, confidential customer information, protected personally-identifiable data. In those instances, recording of the video conference could result in undesirable security breaches, potentially resulting in significant liability, embarrassment, or other undesirable results.

Certain video conferencing programs may provide limited mechanisms for recording video conferencing. For example, systems and methods herein may allow meeting settings to be changed to let only the host or certain users to utilize certain meeting software features, such as meeting recordings. Often these permissions to access meeting features are distributed by provisioning systems, which assign entitlements to users. An entitlement grants a user permission to access certain features that the user cannot access within a system by default. An entitled user may be granted permission to record all video conferences with which they are involved, in contrast to a non-entitled user who is not allowed to record any video conferences.

Video conference meeting software provisioning systems may not allow for entitlements to be granted on a per meeting basis. Additionally, video conference meeting provisioning systems may not rely on using meeting contexts to assign entitlements. Instead, they may more generally rely on user or device roles. Given the potential for sensitive information to be raised in a video conference meeting, an organization may wish to restrict recording meeting entitlements. Thus, it may be desirable to provide a contextual entitlement provisioning system for video conference meeting software to allow or disallow meeting recording permission on a per meeting basis.

Example systems and methods disclosed here include a system for video conference meeting provisioning, which includes a provisioning application for assigning entitlements (e.g., entitlements to record video conference meetings, attend video conferences, speak during a video conference, present materials during a video conference) on a per meeting basis. Systems and methods herein can mitigate risk of personal discretion regarding whether to use, or not use, recording technology in a specific instance. Systems and methods herein can align with an organization's policies, culture, legal risk, retention schedules, training/demonstration needs, to provide recording functionality when it is appropriate for that organization (which may differ from other organizations), while providing mitigation of risks from errors in judgment. The provisioning application can authorize use of meeting recording functions for a specific meeting based upon meeting context information identified from a user request and preexisting data. In some examples, this allows meeting recording entitlements to be tailored to only video conference meetings with approved contexts for recording and prevent unauthorized recording of other video conference meetings.

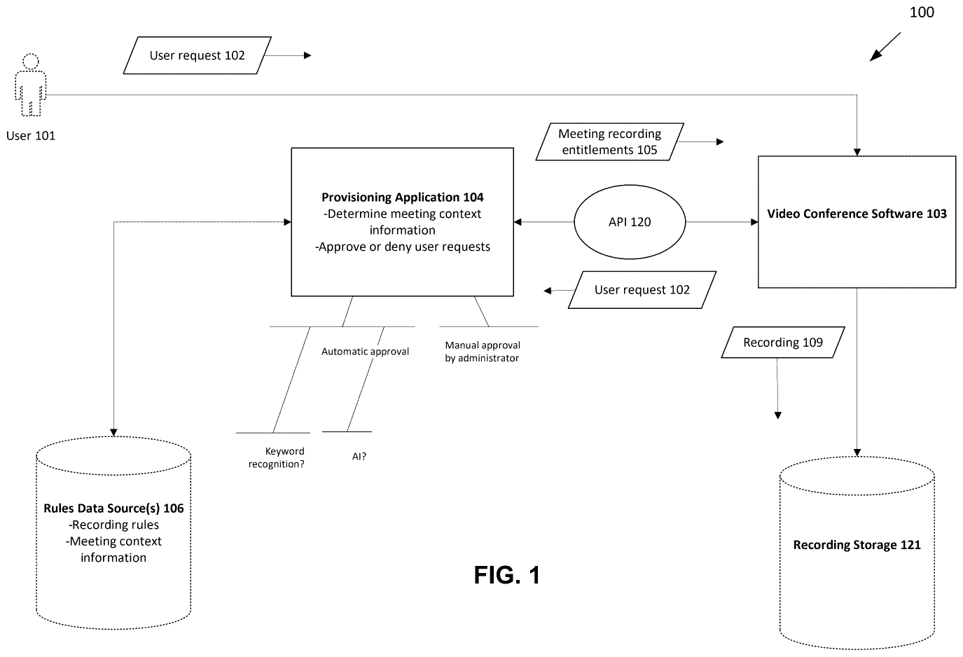

FIG. 1 depicts an example system for video conference provisioning 100. The system 100 includes a provisioning application 104 that draws on a rules data source 106 and communicates meeting recording entitlements to video conference software 103. In embodiments, the video conference software 103 stores the meeting recordings in one or more recording storage 121 locations.

In the example depicted in FIG. 1, a user 101 submits a user request 102 for a video conference meeting to a video conference software 103. The video conference software 103 may be Microsoft Teams, Zoom, Webex, or another video conference software. The video conference software may be capable of running online meetings with audio, video, or text-based communication. And the video conference software may be capable of recording meetings, and delivering the meetings to one or more recording storage 121 locations.

In an example, the user request 102 submitted to the video conference software 103 may require or allow for the input of information including the proposed meeting's date, time, the purpose of the meeting, the number of attendees, the number of potential moderators, if the audience is composed of attendees internal or external to the host's organization, and other meeting information. The user 101 may also request a specific meeting recording entitlement 105 to obtain permission to record their specific video conference meeting.

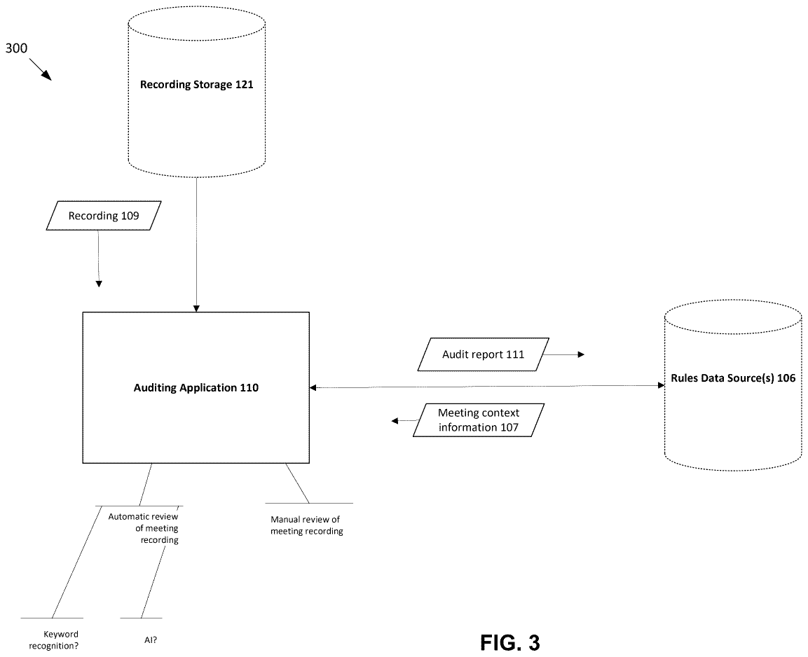

The video conference software communicates the user request 102 to the provisioning application 104. The video conference software and the provisioning application 104 may, for example, communicate via an application programming interface (API) 120. Or in other embodiments, the provisioning application 104 may directly integrate with the existing video conference software 103. The provisioning application 104 may be its own application or may encompass a collection of applications. In different embodiments, the provisioning application 104 may be an overlay on the graphical user interface of the video conference software 103, or may have its own graphical user interface. The provisioning application 104 identifies meeting context information from the user request 102 communicated via the video conference software 103. The meeting context information may be derived from the user request 102, a rules data source 106, or a combination of the two. The rule data source 106 may, for example, contain information regarding a user's seniority in an organization, role in the organization, prior meeting history in the organization, past meeting history and information from an auditing application (depicted in FIG. 3). In another example, a recording approval may be based on the indicated attendees for the meeting (e.g., whether all invitee email addresses are internal to an organization) or an indicated topic for the meeting (e.g., based on the appearance of the word “Training” in the meeting title). Additionally, the rules data source 106 may contain set rules for allowing or disallowing meeting recording entitlements based off set standards, past precedent, organizational seniority, meeting purpose, and/or other criteria.

The provisioning application 104 may allow or disallow meeting recording entitlements for a video conference meeting based upon the meeting context information. In certain embodiments, the rules data source 106 may include a set of rules to enable the provisioning application to perform an automatic evaluation of the user request 102. Automatic approval of the meeting context information may use keyword recognition, artificial intelligence, or another method. The provisioning application 104 may also allow or disallow meeting recording entitlements 105 based on a manual review by an administrator. The provisioning application 104 may, for example, provide suggested meeting recording entitlements 105 to an administrator, CEO, or other poweruser based upon an automatic evaluation of the meeting context information. In embodiments, the provisioning application 104 may use a combination of automatic and manual review for allowing or disallowing meeting recording entitlements 105.

In embodiments, any initial decision or recommendation by the provisioning application 104 is non-final and is subject to manual override. For example, a user who is not satisfied (e.g., with an automatic record permission denial) may request an override, such as from an administrator or a manager. An administrator, manager, or other person with sufficient authority may otherwise provide specific approvals, such as for allowing meeting recording entitlements 105, on their own or based on a request from a user received via email, the provisioning application 104, or otherwise. In various embodiments provisioning system access privileges prohibit the user from modifying meeting recording entitlements, whereas the provisioning system access privileges granted to an administrator, manager, or other person with sufficient authority permit the modification of the user's recoding entitlements. In some cases, the right to modify the user's recording entitlements are further constricted by the user group to which the user or the administrator, manager, or other person with sufficient authority belong (e.g., some administrators can only modify privileges for certain users, a manager can only modify privileges of employees in that manager's department).

The provisioning application 104 assigns one or more meeting recording entitlements 105 to the video conference software 103, which enables the software's meeting recording function. In some examples, the meeting recording entitlements 105 may be granted to one or more users in a video conference meeting, or in other examples, be granted to all users in the video conference meeting. The video conference software can create a meeting invite 106 with the meeting recording function set based on the meeting recording entitlements 105. The meeting invite 106 may, for example, be an online calendar invitation. The meeting invite 106 may include a hyperlink to a video conference meeting that opens with the meeting recording entitlements 105 granted by the provisioning application 104 built in.

In addition to being applicable to a single meeting (e.g., with a single meeting ID), meeting recording entitlements 105 may be associated with a plurality of meetings. For example, a meeting recording entitlement 105 may be associated with a meeting subject or a meeting topic such that a particular meeting recording entitlement 105 is applied to all meetings having that meeting subject or meeting topic. Such a capability can allow a requesting user to make a single user request 102 that applies to multiple meetings. For example, a user request 102 could request permission to record instances of a recurring meeting that will be held periodically (e.g., a workshop on a particular topic that is held monthly). An approval of that user request 102 would provide meeting recording entitlements 105 to any meeting that falls within the scope of that user request 102. That scope could be determined by a system in a variety of ways. For example, the video conference software 103 or the API 120 could compare a meeting invite subject to a text string associated with the meeting recording entitlement 105 to determine whether the entitlement 105 applies to that meeting. In an example, some processing of the meeting invite subject, such as removal of certain prefixes such as “RE:” and “FW:”, could be performed before comparing the meeting invite subject to a meeting invite string associated with the entitlement 105 to identify a match. In another example, a system compares a meeting invite subject or other contextual information associated with a meeting to a topic associated with a meeting recording entitlement 105. For example, a Levenshtein distance could be calculated between a meeting invite subject and an entitlement topic, where the entitlement 105 is applied or not applied based on a comparison of the calculated distance and a threshold. In another example, an artificial intelligence model is provided the meeting invite subject and/or additional contextual information associated with a meeting and a topic associated with the entitlement 105 to determine whether the entitlement 105 applies to the particular meeting.

In certain examples, such a topic-specific meeting recording entitlement 105 is associated with a time period (e.g., one month, one year, three years), such that the duration of any approvals associated with that entitlement 105 do not apply to meetings that occur outside of that time period (e.g., meetings that occur more than one year after the entitlement is approved, meetings that are scheduled via a request submitted more than one year after the entitlement is approved). In certain examples, meeting recording entitlements 105 that expire are automatically forwarded to the requesting user or to an administrator to consider requesting approvals/approving for an additional period of time.

The meeting recording entitlements 105 may be provided to or accessed by the video conference software 103 in a variety of ways. In one example, the provisioning application 104 interacts with the video conference software 103 via API 120 (e.g., the video conference software 103 is subscribed to API 120). When a meeting is requested by a user 101 and recording permissions are determined, the provisioning application 104 may communicate information to the video conference software 103 to schedule and otherwise setup the meeting, including transmitting meeting recording entitlements 105. The meeting recording entitlements 105 transmitted to the video conference software 103 may then be implemented during the particular meeting associated with the entitlements 105. As described further herein, in some instances meeting recording entitlements 105 may be manually or automatically overridden during a video conference, such as when a regulated person attends or presents in a meeting such that recording is mandated for compliance, regulatory, or other reasons.

In addition to a communication from the provisioning application 104 to set up a video conference, meeting recording entitlements 105 may be ascertained by the video conference software 103 in other ways in certain examples. For example, video conference software may apply certain meeting recording entitlements 105 by default, e.g., all attendees are permitted to record, a meeting organizer is permitted to record, no recording is permitted. Automatically at the start of the meeting, or when a recording operation occurs or does not occur during a meeting, the video conference software 103 may query a repository (e.g., a repository of video conference data structures as discussed further herein) to determine whether any meeting specific entitlements have been set for the present meeting (e.g., query a database to determine whether any meeting specific entitlements are set for a meeting at the current date/time associated with the meeting initiator or other attendee). If meeting-specific entitlements are set for that meeting, the video conference software 103 may apply the meeting-specific entitlements instead of the default recording entitlements. Such a query by the video conference software 103 may be via the previously discussed API 120 or via a different communication channel.

If the meeting recording function is enabled, the video conference software may allow recording of the meeting by the users granted an entitlement to record. If the meeting recording function is enabled, the video conference software generates a meeting recording 109. The meeting recording 109 may be stored in a recording storage 121 location. In certain examples, if the meeting recording function is enabled, the video conference software generates a record of the meeting, which may include additional metadata information, such as meeting length, number of attendees, a list of attendees, or other variables. This meeting record metadata may also be stored in one or more recording storage 121 locations so as to create an audit trail for the video recording, such as for compliance purposes.

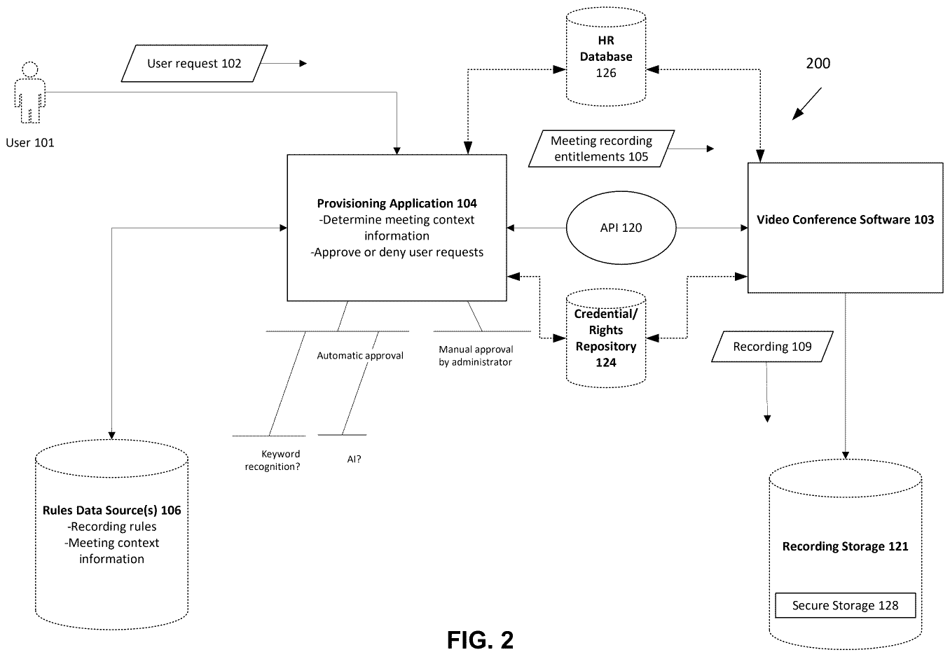

In certain examples, the user communicates the request directly to the provisioning application, where the provisioning application then provisions the video conference by setting up the meeting in the video conference software such that a link or invitations to participants is provided and transmitting the meeting recording entitlements to the software to be enforced during the scheduled video conference. FIG. 2 depicts such an example of a system for video conference provisioning 200. This example is similar to the example shown in FIG. 1, except that the user request 102 is submitted directly to the provisioning application 104 and is not routed through the video conference software 103. In this example, the provisioning application 104 may interact with the video conference software to initiate scheduling a meeting with allowed or disallowed meeting recording entitlements 105.

In embodiments, one or more resources of a system may be responsive to a credential/rights repository 124 that regulates access to resources. For example, as noted above, in some instances, meeting recording entitlements may be granted, denied, or overridden by an administrator. In order to perform those actions relative to recording entitlements, the administrator may need to be authenticated at the provisioning application 104, video conference software 103, or other entity in the system by presenting credentials indicating the administrator's identity (e.g., a username/password, a 2FA key, biometric data, a certificate). The administrator's credentials are validated using the repository 124. In embodiments, validating the administrator's credentials may also include verifying a level of rights that the administrator has been given using information stored in the repository 124 or elsewhere. In some embodiments, certain limited actions may be taken by users (e.g., requesting permission to record a meeting) without validation of credentials, where other restricted functions (e.g., granting, denying, or overriding permissions; unrestricted recording access permissions) are only permitted to administrators or other users whose credentials and/or access rights have been verified. Because information stored in the credential/rights repository itself may be sensitive in nature, in some embodiments, computing entities such as the video conference software 103 and provisioning application 104 may need to provide authentication data (e.g., to the repository 124) to subsequently access data in the repository 124.

In addition to storing rights data in repository 124, such data may be stored directly or indirectly in other locations. For example, rights to interact with a system may be, in whole or in part, based on a user's role in an organization. In one embodiment, a user authenticates their identity by presenting credentials that are verified via repository 124. That authenticated user's role in the organization (e.g., administrator, general user, regulated user) may then be accessed via an HR database 126, where decisions by the system are determined, at least in part, based on the user's role. For example, an authenticated administrator user may be granted privileges to access, grant, deny, or override meeting recording privileges based on data from repository 124 and database 126.

As another example, recording of a meeting may automatically be controlled by the provisioning application 104 or the video conference software 103 based on data from those repositories 124, 126. For example, an organization may require recording of any meeting where a regulated person and a third party are present or active (e.g., presenting in a meeting, speaking in a meeting, attending a meeting). In an embodiment, when a person who is indicated by the HR database 126 to be a regulated person is invited to a meeting, that meeting may be set for automatic recording. In another example, where a regulated person logs into a meeting, the video conference software 103 may be instructed to automatically begin recording. In a further example, recording may be triggered when a regulated person, as indicated by data from the HR database 126, begins to transmit, speak, or otherwise participate in the meeting (e.g., a trigger based on one or more of the regulated person sharing their screen, unmuting their microphone, or turning on their camera). In some instances, those recording triggers may only be initiated when the meeting further includes a third party (e.g., a person for which the HR database does not include a personnel record). The presence or participation of a regulated person may further trigger storage of a recording in a segregated portion 128 of the recording storage 121 or in a wholly separate repository. Recordings in that secure storage 128 may only be viewable by users having certain levels of access (e.g., administrators, managers) as indicated by data from repository 124 or database 126. Additionally, or alternatively, file rights to recordings involving regulated persons may otherwise be modified (e.g., password protection) so as to control access to those recordings compared to less sensitive recordings (e.g., company trainings).

In at least some embodiments, the provisioning application 104, the repository 124, and the video conferencing software 103 and associated datastores each contain information that is confidential with regard to each other, such that authentication into one system (e.g., 103, 104, or 124) provides only limited or restricted access into the other system (e.g., 103, 104, or 124) respectively. For example, in at least one embodiment, video recording application 103 must authenticate as a user to access to functionality provided by provisioning application 104, which in turn must authenticate as a user of repository 124 in order to access relevant meeting recording entitlements. In some embodiments, video recording application 103 further authenticates as a user of application provisioning system 104 and receives entitlement information containing entitlements to access relevant data in relevant systems and APIs (e.g., 103, 104, 120, 124, 126, 128). In some embodiments, video recording application 103 provides the relevant entitlement information to application 104 or API 120, which in turn confirms the entitlement information with provisioning application 104 before application 104 or provisioning application 120 request the meeting recording entitlements or provide such entitlements to video conferencing software 103. Such entitlement information (system access entitlements and/or meeting recording entitlements) may be provided in any acceptable form. In some embodiments entitlements may be provided in a tokenized form. In this way, each system involved, and each user involved, may require entitlements provided by provisioning application 104 to access one or more or all of the disparate systems involved in the entitlement provisioning process. In embodiments provisioning application 104 may in practice be multiple disparate provisioning systems.

As noted above, it may be desirable to track metadata associated with a video conference to provide an audit trail for the recording. It may be desirable to track a variety of metadata associated with a recording, such as what account initiated the recording, the date and time of the recording, the live attendees of the recorded sessions, which attendees participated (e.g., spoke) during the recorded session, a storage location of the recording, a verification that the recording matches the purported metadata associated with the meeting (e.g., was the meeting actually on the topic noted in the meeting title, were off-topic discussions included in the recording), and what accounts have accessed the recording.

FIG. 3 depicts another example of a system for video conference provisioning 300 that includes an auditing application 110. The auditing application 110 may, for example, be used to verify if the meeting recording 109 corresponds to the meeting context information as originally identified by the provisioning application 104. The auditing application may, for example, be part of the same program as the provisioning application 104 or the auditing application 110 may be separate from the provisioning application 104. There may be a separate graphical user interface for the auditing application 110 of the provisioning software, or the auditing application 110 may be integrated with the graphical user interface of the provisioning application 104. In certain embodiments, the auditing application 110 may be configured to perform an automatic review of the meeting 109 and the meeting context information. The automatic review may include speech-to-text identification, keyword searching, artificial intelligence, or other types of review to confirm that the recorded meeting was as-expected (e.g., the detected content of the meeting was in line with the purported topic for the meeting). In other examples, the auditing application 110 may be used by an administrator to perform a manual review of the meeting recording 109 and the meeting context information. In embodiments, the auditing application 110 may be used by an administrator to perform a manual review of the meeting recording 109 and the meeting context information in combination with an automatic process. The auditing application 110 may, for example, automatically suggest an audit result for manual approval by an administrator.

The auditing application 110 may be used to produce an audit report 111 based upon the verification and/or review process. The audit report may include the meeting recording 109, the user request 102, the approved meeting recording entitlements 105, any verification data created by the auditing application 110 either automatic or manual, and/or any discrepancies identified. The audit report may be used to update the provisioning application's rules data source 106. The audit report may be available for administrators to review. The auditing application 110 may, for example, automatically flag discrepancies between the user request 102 and the meeting recording 109, and may notify administrators of such discrepancies, for example in the audit report 111.

In one example, anomalies in the audit trail information may be utilized to raise and alert for further investigation or action. For example, when a review of the content of a recording, such as via automatic speech recognition transcribing and/or an artificial intelligence content detection model, indicates a mismatch of the detected content of a meeting and its purported purpose from the user request 102, an alert may be issued for further review. For example, a message may be transmitted to a Security Information and Event Management system (SIEM) to trigger additional automatic or manual review. In some instances, interim action may be taken to mitigate risk, such as quarantining the meeting recording 109 until its actual content can be cleared as a non-risk.

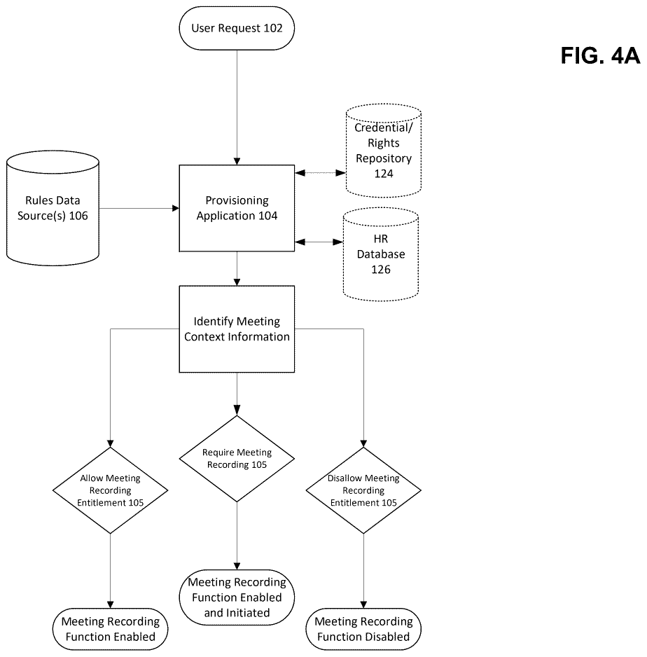

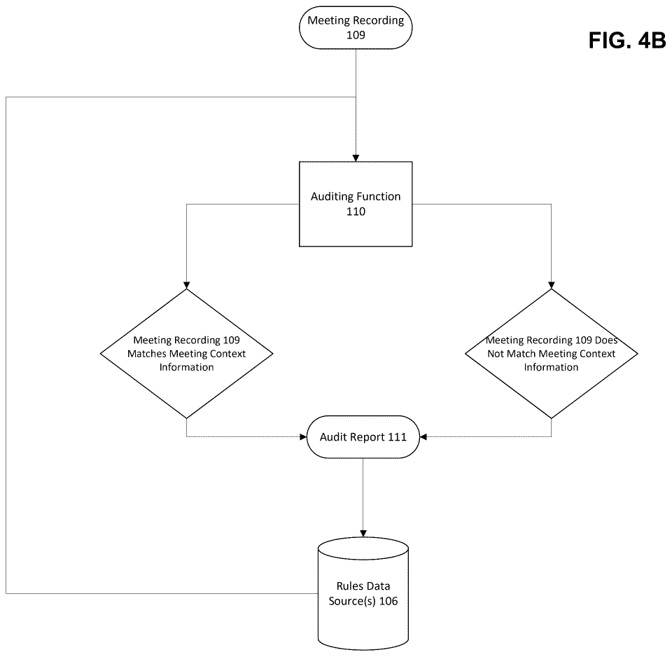

FIG. 4A is flow diagram depicting a provisioning application evaluating a request for a video conference with recording enabled, as discussed above under FIGS. 1 and 2 above. In this example, a user request 102 is submitted to a provisioning application 104, which utilizes the user request 102 and one or more data sources 106 to identify meeting context information. Then the provisioning application will allow or disallow a meeting recording entitlement 105. If the meeting recording entitlement 105 is allowed, the meeting recording entitlement enables the meeting recording function of the video conference software. If the meeting recording entitlement 105 is disallowed, the meeting recording entitlement does not enable the meeting recording function of the video conference software. In examples, meeting recording entitlements 105 may be automatically allowed based on the meeting context information. Automatic approval of the meeting context information may use keyword recognition, artificial intelligence, or another method. In other examples, the provisioning application 104 may allow or disallow meeting recording entitlements 105 based on a manual review by an administrator. In another embodiment, the provisioning application may allow or disallow meeting recording entitlements 105 based on a combination of automatic and manual review; for example, the provisioning application 104 may provide suggested meeting recording entitlements 105 to an administrator based upon an automatic evaluation of the meeting context information. Still further, certain data (e.g., from credential/rights repository 124, HR database 126) may indicate that meeting recording is mandatory. For example, when a regulated individual is invited or present in a meeting that includes third parties, the provisioning application 104 may enable recording at the video conference software 103 and further indicate that recording must be initiated for the meeting to proceed.

FIG. 4B is a flow diagram depicting an auditing application which may be included in the provisioning application. The auditing application verifies a meeting recording matches meeting context information, as discussed above under FIGS. 1 and 2 above. A meeting recording 109 is received by an auditing function 110 of the provisioning application. The auditing function 110 evaluates the meeting context information and the meeting recording 109. The auditing function 110 produces an audit report 111, which is sent to the rules data source 106.

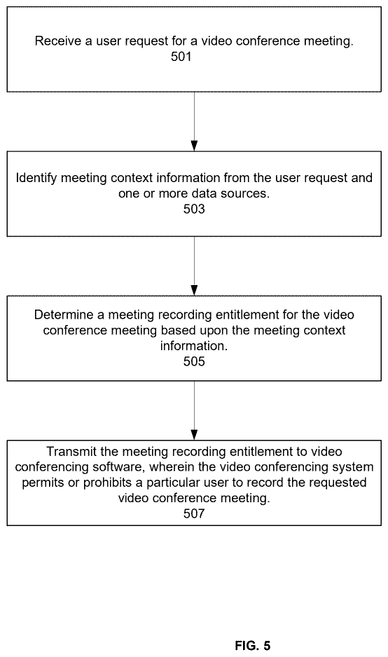

FIG. 5 is a flow diagram depicting a method for video conference meeting provisioning. A user request for a video conference meeting is received, as shown at 501. At 503, meeting context information is identified from the user request and one or more data sources. At 505, a meeting recording entitlement for the video conference meeting is determined based upon the meeting context information. And at 507, the meeting recording entitlement is transmitted to video conferencing software, where the video conferencing software permits or prohibits a particular user to record the requested video conference meeting.

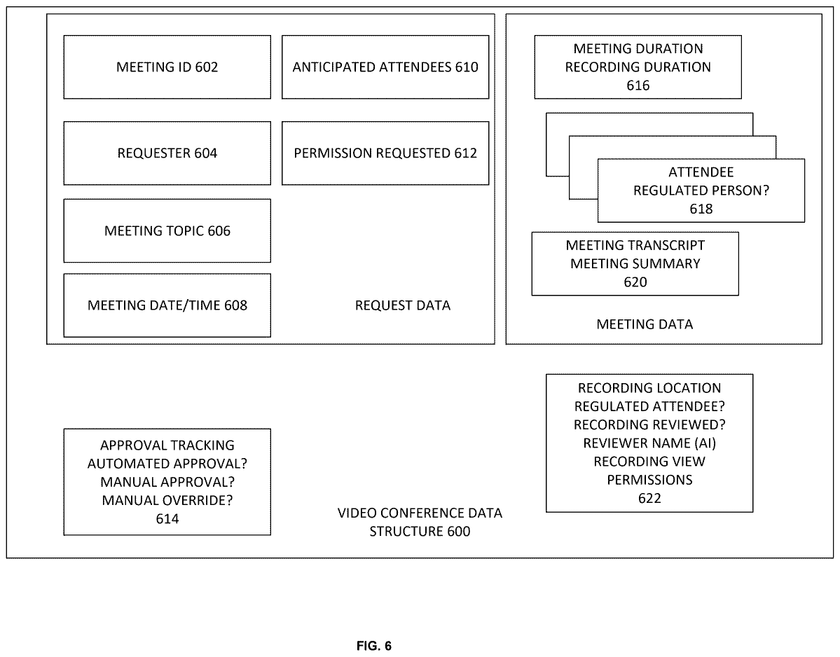

Systems and methods as described herein may utilize a variety of paradigms for tracking and implementing video conference rights provisioning as described herein. For example, each video conference provisioned via a provisioning application, or all video conferences associated with an organization, may be tracked via a video conference data structure. FIG. 6 is a diagram depicting an example video conference data structure. In one example, a video conference data structure 600 is generated upon receipt of a request for a video conference at a provisioning application. A meeting ID 602 is assigned and data about the meeting is collected, such as an identity of the requester 604, a topic associated with the meeting 606 (e.g., a subject line that wille be included on meeting invites for that meeting), a date and time for the meeting 608. In some instances, a list of anticipated attendees 610 is collected. The anticipated attendees 610 may be particular identifications of persons to which invitations will be sent and whether the particular attendee will be able to participate in the meeting (e.g., speak, share screen, present slides, show video). In some embodiments, the anticipated attendees 610 may be identified as classes of attendees. For example, the anticipated attendees record 610 may indicate whether expected attendees are internal or external to the organization of the requester. The anticipated attendees record 610 may further indicate whether of the expected attendees are regulated attendees who are only permitted to communicate via approved channels (e.g., individuals who are only permitted to communicate via retained messages for compliance, regulatory, or other reasons). The data structure 600 may further track the type of permission 612 requested by the requester, such as whether the requester is requesting audio recording of the video conference or video recording of the video conference. In implementations where all meeting requests are made via a provisioning application, regardless of whether recording permissions are requested, the permission requested may be indicate that no video or audio recording is requested.

The example video conference data structure 600 further includes data 614 associated with the approval and assignment of permissions to the meeting. As described above, approvals may be automated, semi-automatic, or manual. For example a rules engine or artificial intelligence (e.g., neural network) model may initially approve or deny permission requests based on rules or training data associated with previous requests/approvals. In some embodiments, that initial automated decision may be overridden, such as by a manual override by a manager or other person with sufficient supervisor permissions. In some instances, recording sessions may be automatically set based on the request data regardless of the permission requested 612. For example, if the anticipated attendees 610 include regulated persons, the meeting may be set for recording regardless of whether recording permissions were requested at 612.

The video conference data structure 600 may further track data associated with the actual meeting. The meeting data may include the actual date, time, and duration of the meeting. That data 616 may also include the type, timing, and duration of the recording (e.g., video recording starting at 10:02:45 EST ending at 11:01:04 EST). The meeting data may also include data associated with each attendee at 618. Attendee information may indicate the identify, for each attendee, the identity of the person, the timing of the attendees presence in the meeting, whether the attendee spoke or otherwise presented in the meeting, and whether the attendee is a regulated person. In some instances, when a regulated person logs into a meeting, recording may automatically be started (e.g., with an alert to all attendees or without) to maintain regulatory or other compliance). In other examples, recording may automatically begin during a meeting when a regulated person speaks or otherwise presents (e.g., shares screen, turns on video) during a meeting.

In some examples, a meeting transcript 620 is generated and tracked via a video conference data structure 600. Transcript generation may be part of a permission request 612, may be generated in all instances, may be generated in all meetings where recording is permitted or occurs, may be generated in any instance where a regulated person participates, or otherwise. The meeting transcript 620 may be generated by automated speech recognition software or may be provided via human transcription. In some instances, an artificial intelligence model may review the meeting transcript 620 and provide a meeting summary. That meeting summary 620 may be retained in the data structure 600 for future reference, may be transmitted to certain persons (e.g., an email recap of the meeting to managers), or may be used for compliance purposes as a check to make sure that the meeting substance matches the meeting topic 606.

The video conference data structure 600 may further track data associated with any recording and compliance review. For example, that data 622 may include a location of the recording and retention information associated with the recording. For example, the data 622 may indicate a length of time that the recording should be maintained. In some instances, that retention information originates in the request. In other instances, that retention period is based on organization protocols, where in one example a retention period is determined based on an indicated or detected meeting topic 606. In some examples, a hold may be indicated at 622 or otherwise to prevent disposal of the record, such as in the instance of litigation. A system may be configured to automatically retain or purge the recording and/or its associated data structure 600 based on the data tracked in the video conference data structure 600 (e.g., purge videos and data structures over 5 years old where no regulated person was in attendance and no litigation hold is in place).

The recording data 622 may further track data associated with review of the recording. For instance, data may be recorded that indicates a person who performed a manual review of the meeting recording to verify attendees and that the meeting was on topic. In other instances, a recording review may be automated. In one example, an artificial intelligence engine compares a meeting transcript/summary 620 to the purported meeting topic 606 to determine whether the meeting substance was on topic and appropriate. In instances where a recording is manually or automatically determined to be off topic, an alert communication or other flag may be raised to initiate follow up review, such as by a manager.

In some instances, the recording data 622 may indicate whether a regulated person was present in the meeting or presented in the meeting. The presence of a regulated person may trigger automated or manual substance review of the recording. The presence of a regulated person may also affect permissions on who is permitted to view the recording. For example, certain persons may be authorized or prevented from viewing recordings where a regulated person was present or presented. The video conference data structure 600 may contain data regarding who is permitted to access the recording and/or metadata (e.g., the video conference data structure 600) associated with the recording. The data structure 600 may further include information associated with actual accesses of the recording, such as identity, date, time, duration, and portions of the recording viewed.

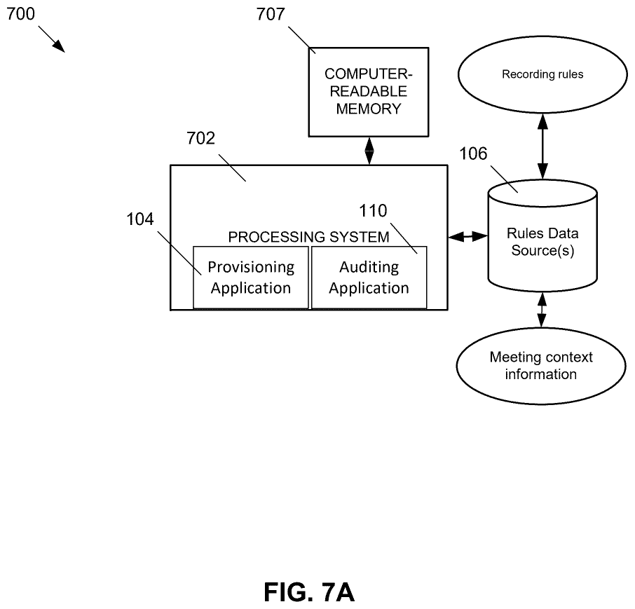

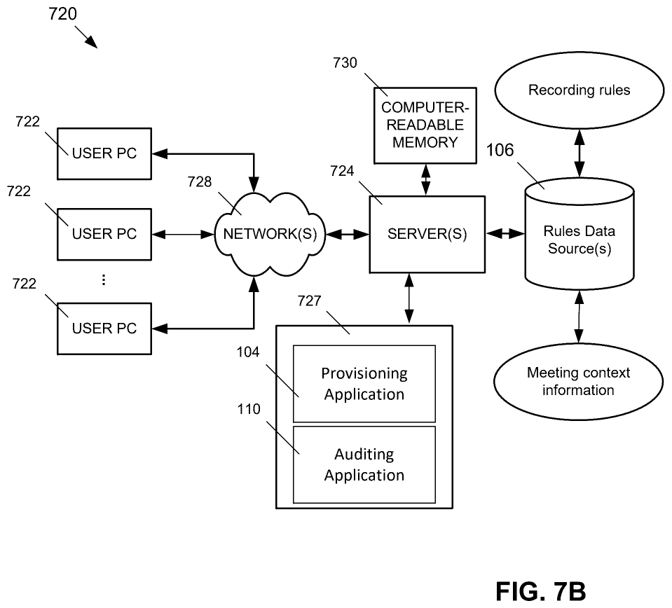

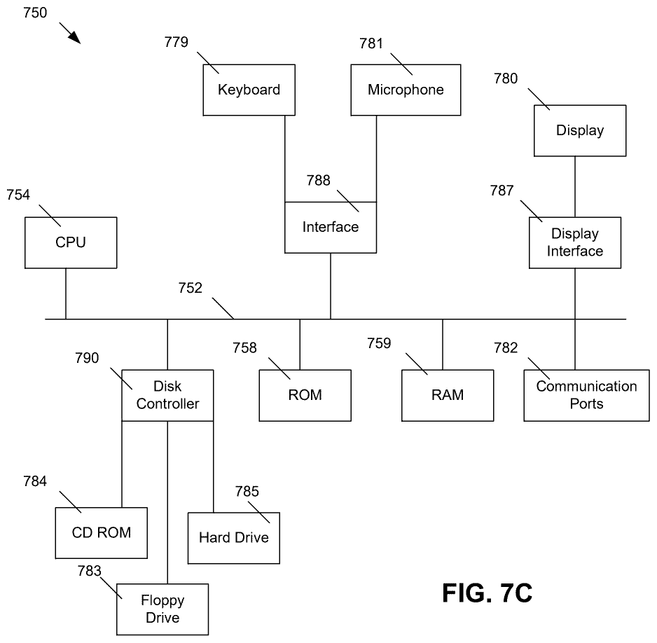

FIGS. 7A, 7B, and 7C depict example systems for implementing the approaches described here for implementing contextual video conference meeting provisioning. For example, FIG. 7A depicts an exemplary system 700 that includes a standalone computer architecture where a processing system 702 (e.g., one or more computer processors located in a given computer or in multiple computers that may be separate and distinct from one another) includes a computer-implemented provisioning application 104 and a computer-implemented auditing application 110 being executed on the processing system 702. The processing system 702 has access to a computer-readable memory 707 in addition to one or more rules data source 106. The one or more rules data sources 106 may include recording rules as well as meeting context information. The processing system 702 may be a distributed parallel computing environment, which may be used to handle very large-scale data sets.

FIG. 7B depicts a system 720 that includes a client-server architecture. One or more user PCs 722 access one or more servers 724 that include a provisioning application 104 and a auditing application 110 operating on a processing system 727 via one or more networks 728. The one or more servers 724 may access a computer-readable memory 730 as well as one or more rules data sources 106. The one or more rules data sources 106 may include recording rules as well as meeting context information.

FIG. 7C shows a block diagram of exemplary hardware for a standalone computer architecture 750, such as the architecture depicted in FIG. 7A that may be used to include and/or implement the program instructions of system embodiments of the present disclosure. A bus 752 may serve as the information highway interconnecting the other illustrated components of the hardware. A processing system 754 labeled CPU (central processing unit) (e.g., one or more computer processors at a given computer or at multiple computers), may perform calculations and logic operations required to execute a program. A non-transitory processor-readable storage medium, such as read only memory (ROM) 758 and random access memory (RAM) 759, may be in communication with the processing system 754 and may include one or more programming instructions for preventing unauthorized access to a computing system. Optionally, program instructions may be stored on a non-transitory computer-readable storage medium such as a magnetic disk, optical disk, recordable memory device, flash memory, or other physical storage medium.

In FIGS. 7A, 7B, and 7C, computer readable memories 707, 730, 758, 759 or data stores 106, 783, 784, 785 may include one or more data structures for storing and associating various data used in the example systems. For example, a data structure stored in any of the aforementioned locations may be used to store data from XML files, recording rules, meeting context information, and/or data for other variables described herein. A disk controller 790 interfaces one or more optional disk drives to the system bus 752. These disk drives may be external or internal floppy disk drives such as 783, external or internal CD-ROM, CD-R, CD-RW or DVD drives such as 784, or external or internal hard drives 785. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 790, the ROM 758 and/or the RAM 759. The processor 754 may access one or more components as required.

A display interface 787 may permit information from the bus 752 to be displayed on a display 780 in audio, graphic, or alphanumeric format. Communication with external devices may optionally occur using various communication ports 782.

In addition to these computer-type components, the hardware may also include data input devices, such as a keyboard 779, or other input device 781, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method for video conference meeting provisioning, comprising:
receiving a user request for a video conference meeting;
identifying meeting context information from the user request and one or more data sources;
determining a meeting recording entitlement for the video conference meeting based upon the meeting context information; and
transmitting the meeting recording entitlement to video conferencing software, wherein the video conferencing software permits or prohibits a particular user to record the requested video conference meeting.

2. The method of claim 1, wherein the user request is received through the video conferencing software.

3. The method of claim 1, wherein the determination of the meeting recording entitlement is automatic.

4. The method of claim 1, wherein the determination of the meeting recording entitlement based on a manual review.

5. The method of claim 1, wherein the determination of the meeting recording entitlement based on a combination of automatic and manual review.

6. The method of claim 1, wherein a graphical user interface of the provisioning application is integrated with a graphical user interface of the video conferencing software.

7. The method of claim 1, wherein a graphical user interface of the provisioning application is separate from a graphical user interface of the video conferencing software.

8. The method of claim 1, further comprising verifying whether a video conference meeting recording corresponds to the meeting context information.

9. The method of claim 8, wherein the verifying if a video conference meeting recording corresponds to the meeting context comprises manual review.

10. The method of claim 8, wherein the verifying if a video conference meeting recording corresponds to the meeting context comprises automatic review.

11. The method of claim 8, wherein the verifying is performed by an auditing application.

12. The method of claim 11, wherein the verifying produces an audit report based upon the verification.

13. The method of claim 12, wherein the auditing application is configured to update a provisioning application data source based upon the audit report.

14. A system for video conference meeting provisioning, comprising:
a provisioning application software on a non-transitory computer readable medium and executable by one or more processors, the provisioning application configured to receive a user request for a video conference meeting, identify meeting context information from the user request and one or more data sources, and allow or disallow one or more meeting recording entitlements for the video conference meeting based upon the meeting context information;
wherein the meeting recording entitlements enables a meeting recording function of the video conference software.

15. A system for video conference meeting provisioning, comprising:
one or more data processors;
one or more computer-readable mediums encoded with instructions for commanding the one or more data processors to execute steps comprising:
receiving a user request for a video conference meeting;
identifying meeting context information from the user request and one or more data sources;
determining a meeting recording entitlement for the video conference meeting based upon the meeting context information; and
transmitting the meeting recording entitlement to video conferencing software, wherein the video conferencing software permits or prohibits a particular user to record the requested video conference meeting.

16. The system of claim 15, wherein an auditing function is configured verify if a video conference meeting recording corresponds to the meeting context information.

17. A method for video conference meeting provisioning, comprising:
receiving a user request for a video conference meeting;
identifying meeting context information from the user request and one or more data sources;
determining a meeting entitlement for the video conference meeting based upon the meeting context information; and
transmitting the meeting entitlement to video conferencing software, wherein the video conferencing software permits or prohibits a particular user to perform an activity associated the requested video conference meeting based on the meeting entitlement.

18. The method of claim 17, wherein the meeting entitlement is associated with attending a video conference meeting, speaking during a video conference meeting, presenting materials during video conference meeting or recording a video conference meeting.

19. A system for video conference meeting provisioning based on a user request for a video conference meeting that includes meeting context information, comprising:
means for determining a meeting recording entitlement for the video conference meeting based upon the meeting context information; and
an interface configured to transmit the meeting recording entitlement to video conferencing software, wherein the video conferencing software permits or prohibits a particular user to record the requested video conference meeting.

20. A non-transitory computer-readable medium encoded with a data structure that tracks data associated with a video conference, the data structure comprising:
a requester identifier indicating an identity of a requester of the video conference;
a topic record associated with subject matter the video conference;
a date record associated with a date of the video conference;
a recording permission request record indicating whether permission to record the video conference was requested;
a recording permission tracking record indicating whether permission to record the video conference was approved;
a meeting record indicating the date, duration, and attendees of the video conference;
and an audit data record indicating whether a recording of the video conference was reviewed to confirm that subject matter of the recording matches the subject matter of the topic record.

21. The medium of claim 20, wherein the recording permission tracking record indicates whether the approval was automated or manual.

22. The medium of claim 21, wherein the meeting record further includes a transcript of the video conference generated via an automated speech recognition software module.

23. The medium of claim 22, wherein the audit data record indicates that the recording was reviewed based on processing of the transcript and the subject matter indicated in the topic record.

24. The medium of claim 21, wherein the meeting record indicates whether a particular attendee was a regulated person for which recording of the video conference is mandatory.

25. The medium of claim 1, wherein the audit data record indicates a storage location of the video recording, a document retention period associated with the video recording, and an indication of persons who have accessed the video recording.

26. The medium of claim 20, wherein a value associated with the recording permission tracking record is determined based on existence of a multi-meeting recording entitlement record that identifies an entitlement topic, wherein a permission associated with the entitlement record is applied to the data structure when the entitlement topic is determined to match the topic record of the data structure.
